(19) United States
(12) Patent Application Publication
(10) Pub. No.: US 2024/0062606 A1
(43) Pub. Date: Feb. 22, 2024

(54) VOTING SYSTEM AND VOTING PROGRAM

(71) Applicant: ASTERIA CORPORATION, Tokyo (JP)

(72) Inventor: Kazuya MORI, Tokyo (JP)

(73) Assignee: ASTERIA CORPORATION, Tokyo (JP)

(21) Appl. No.: 18/271,740

(22) PCT Filed: Mar. 2, 2021
(86) PCT No.: PCT/JP2021/007971

§ 371 Date: Jul. 11, 2023

(51) Int. Cl. G07C 13/00

(52) U.S. Cl. CPC G07C 13/00

(57) ABSTRACT

To provide a voting system that allows re-voting during a period and makes tampering difficult after certification of votes, there is provided a voting system (100) using a distributed ledger (10) for voting by transferring a voting token (50) from a voting account to a vote-receiving account over a network (9), the voting system (100) including: a token-issuing means (21) for issuing the voting token (50) to the voting account generated by an account generation means; a transaction-information-holding means (22) for holding during a predetermined period, transaction information Tx for transferring the voting token (50) from the voting account to the vote-receiving account; and a recording means for recording the transaction information Tx recorded in the transaction-information-holding means (22) on the distributed ledger (10) at the end of the predetermined period.

### TECHNICAL FIELD

The present invention relates to a voting system and a voting program.

### BACKGROUND ART

A voting system for a survey or for indicating one's intention over a network, such as the Internet, by using, for example, a PC or a mobile terminal is known. For such a voting system, a method for further preventing tampering or verifying identity on the basis of an electronic signature by using a distributed ledger method has been devised (see, for example, PTL 1 to PTL 4).

For example, in a shareholder vote, which is an example of application, there has been a demand for, for example, a voting method that allows, after voting has been performed once, re-voting a plurality of times until a time limit expires.

However, simply allowing re-voting has a problem that, for example, a function against tampering and a function of verifying identity are difficult to be implemented simultaneously.

### CITATION LIST

### Patent Literature

PTL 1: Japanese Patent No. 6511201
PTL 2: Japanese Unexamined Patent Application Publication (Translation of PCT Application) No. 2018-517208
PTL 3: Japanese Patent No. 6325152
PTL 4: Japanese Unexamined Patent Application Publication No. 2019-95884

### SUMMARY OF INVENTION

### Technical Problem

The present invention has been made in view of the above-described problem, and an object thereof is to provide a voting system that allows re-voting during a period and makes tampering difficult after certification of votes.

### Solution to Problem

To address the above-described problem, a voting system according to the present invention is a voting system using a distributed ledger for voting by transferring a voting token from a voting account to a vote-receiving account over a network, the voting system including: token-issuing means for issuing a voting token to the voting account generated by account generation means; transaction-information-holding means for holding during a predetermined period, transaction information for transferring the voting token from the voting account to the vote-receiving account; and recording means for recording the transaction information recorded in the transaction-information-holding means on the distributed ledger at an end of the predetermined period.

### Advantageous Effects of Invention

According to the present invention, it is possible to provide a voting system that allows re-voting during a period and makes tampering difficult after certification of votes.

### BRIEF DESCRIPTION OF DRAWINGS

FIG. 1 is a diagram illustrating an example overall configuration of a voting system according to an embodiment of the present invention.

FIG. 2 includes diagrams illustrating an example functional configuration of a voting application illustrated in FIG. 1.

FIG. 3 is a diagram illustrating an example functional configuration of a server illustrated in FIG. 1.

FIG. 4 is a diagram illustrating example operations in the voting system illustrated in FIG. 1.

FIG. 5 is a flowchart illustrating example operations in the voting system illustrated in FIG. 1.

FIG. 6 is a diagram illustrating example operations after the expiration of a time limit in the voting system illustrated in FIG. 1.

FIG. 7 is a diagram illustrating an example of a vote certification operation in the voting system illustrated in FIG. 1.

FIG. 8 is a diagram illustrating another example embodiment of the voting system according to the present invention.

### DESCRIPTION OF EMBODIMENTS

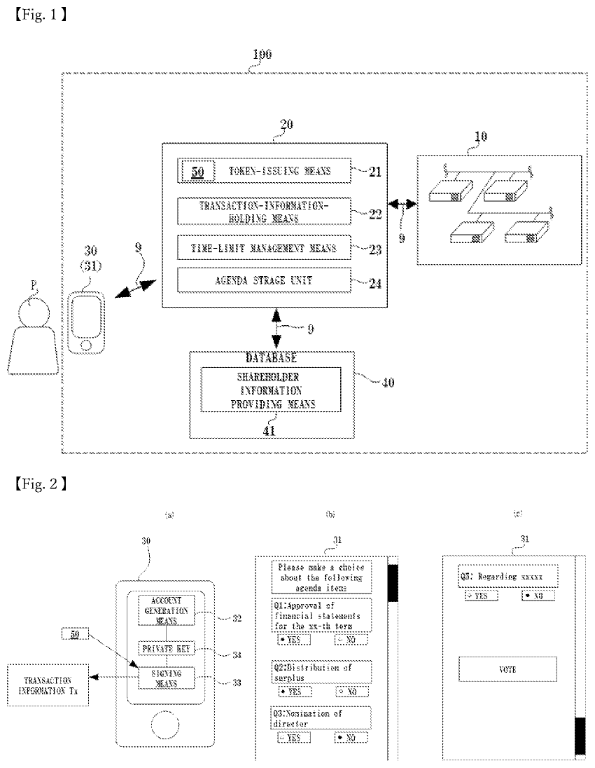

As a first embodiment of the present invention, FIG. 1 illustrates an example overall configuration of a voting system 100 for voting over a network 9, which is, for example, the Internet.

Although this embodiment describes the voting system 100 as a system for a shareholder vote, in which users P who are shareholders reply to each of the plurality of agenda items in, for example, a shareholder meeting with Yes or No, the voting system 100 is not limited to such a configuration.

The voting system 100 includes a mobile terminal 30 for using a voting application 31, a server 20 that is managed by the administrator of the voting system 100, a database 40 that is also managed by the administrator of the voting system 100 and keeps shareholder information, and a blockchain 10 that is a distributed ledger and on which vote results are recorded.

The mobile terminal 30 is a mobile terminal, such as a smartphone or a tablet, that is owned by each user P and on which the voting application 31 can be used, and has a communication function of allowing the mobile terminal 30 to be individually connected to the server 20 over the network 9.

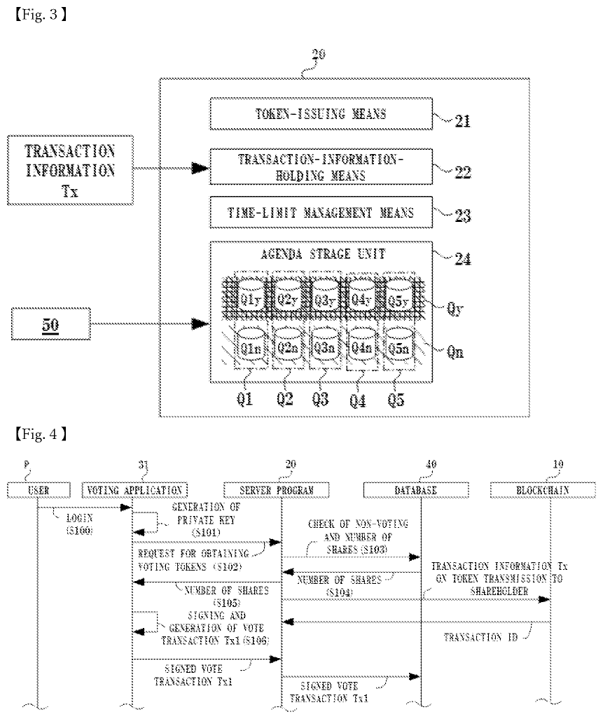

As illustrated in FIG. 2(a), the voting application 31 includes an account generation means 32 for generating a private key 34, thereby generating a voting account, and a signing means 33 for signing voting tokens 50 described below by using the generated private key 34, thereby creating transaction information Tx.

When, for example, a choice about each of the plurality of agenda items is made with Yes or No by using, for example, a radio button as illustrated in FIG. 2(b), and thereafter, the choices are certified by pressing a vote button illustrated in FIG. 2(c), the voting tokens 50 are signed by the signing means 33 and transferred to vote-receiving accounts corresponding to the respective replies. Note that the mobile terminal 30 may be any terminal, such as a PC, as long as the terminal is used by the user P.

The voting application 31 may be a Web application that resides on the server 20 and runs on a Web browser or an application program that is installed on the mobile terminal 30. “Using the voting application 31” means that the voting application 31 is an application program that can be used between the mobile terminal 30 and the server 20. When the voting application 31 resides on the server 20 and is operated by using the mobile terminal 30, the mobile terminal 30 has a function of an application operation unit that operates the voting application 31.

As illustrated in FIG. 3, the server 20 includes a token-issuing means 21 for issuing the voting tokens 50 and a transaction-information-holding means 22 for temporarily saving the transaction information Tx that has been signed and transmitted from the voting application 31.

The server 20 further includes a time-limit management means 23 for broadcasting together pieces of signed transaction information Tx that remain held by the transaction-information-holding means 22 at the end of a predetermined period, to the blockchain 10.

In this embodiment, the server 20 includes an agenda storage unit 24 that functions as vote-receiving accounts and is used to store a plurality of agenda items Q1 to Q5.

In the agenda storage unit 24, for the agenda items Q1 to Q5 that are, for example, agenda items for a shareholder vote, accounts Qy (Q1y, Q2y, Q3y, Q4y, and Q5y) that are vote-receiving accounts to which the voting tokens 50 are cast for a vote in favor and accounts Qn (Q1n, Q2n, Q3n, Q4n, and Q5n) that are vote-receiving accounts to which the voting tokens 50 are cast for a vote in against are respectively saved as addresses.

The database 40 is a database for saving share information including the number of shares owned by each user P, and includes a shareholder information providing means 41 for associating a voting account with shareholder information of a user P who is the owner.

The database 40 may be a database managed by, for example, a trust bank that owns shareholder information or may be any database that saves shareholder information provided from a trust bank.

The shareholder information providing means 41 identifies a user P based on, for example, a login ID used when the user P logs in to the server 20, and returns the number of shares of the user P to the server 20.

The blockchain 10 is a private chain formed by limited participants in this embodiment and is a distributed ledger system on which pieces of transaction information Tx signed by using the private keys 34 corresponding to the voting accounts of a plurality of users P are recorded.

The blockchain 10 is not limited to that described in this embodiment and may be another distributed ledger system, such as a public chain or a consortium chain, other than a private chain.

As the blockchain 10, Ethereum that can count coins on an account basis, NEM, or other UTXO blockchain can be used.

Now, specific operations in the voting system 100 thus configured will be described.

This embodiment assumes that, first, a notification is sent by mail to each user P from, for example, a trust bank that manages shareholder information.

This notification includes the way of obtaining the voting application 31 using the mobile terminal 30 and login information including an ID and a password for the user P.

The notification need not be sent as described above, and may be a notification sent from other than the trust bank or a notification sent from the operator that operates the voting system 100.

It is assumed that the user P first installs in advance on their mobile terminal 30, the voting application 31 for using the voting system 100.

Although this embodiment describes a case of a single shareholder vote, the voting application 31 may generate an account for each of the shareholder votes over a plurality of years or for a plurality of companies and perform similar processing for each of the shareholder votes to thereby implement the plurality of shareholder votes.

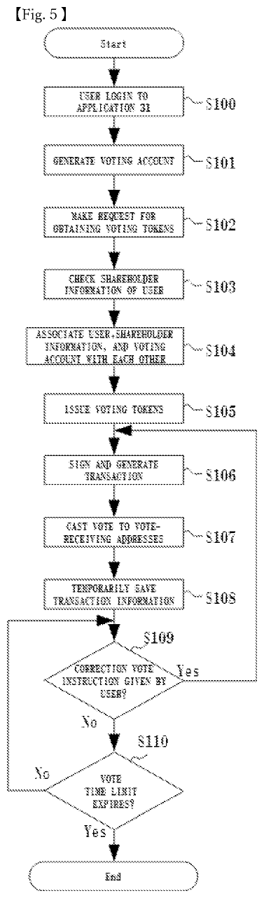

As illustrated in FIG. 4, the user P logs in to the voting application 31 by using the ID and the password included in the login information that is provided in advance (step S100).

In response to proper login, the account generation means 32 of the voting application 31 immediately generates an account, that is, a public key and the private key 34 (step S101).

Next, the voting application 31 makes a request for obtaining the voting tokens 50 to the token-issuing means 21 of the server 20 (step S102).

The server 20 makes an inquiry about shareholder information of the user P to the database 40 on the basis of, for example, the ID and the password used upon login to the voting application 31 and checks whether the user P does not yet perform voting and the number of shares (step S103). At the same time, the server 20 saves an address for the voting account generated by the account generation means 32.

In the database 40, the shareholder information providing means 41 associates the voting account checked in step S103 with shareholder information of the user P who is the owner. The database 40 communicates to the server 20, the number of shares of the voting account about which the inquiry has been made (step S104).

The token-issuing means 21 issues the voting tokens 50 for the voting account on the basis of the number of shares communicated in step S104 (step S105).

At this time, the voting tokens 50 are issued as, for example, five types of different coins for five agenda items so as to correspond to the plurality of agenda items Q1 to Q5 respectively.

In this embodiment, the voting tokens 50 may be implemented as tokens conforming to, for example, the ERC-20 standard of the Ethereum or may be generated by creating other new tokens or virtual currency.

In step S105, the token-issuing means 21 transfers the voting tokens 50 of the respective types to the voting account in accordance with the number of shares obtained from the database 40.

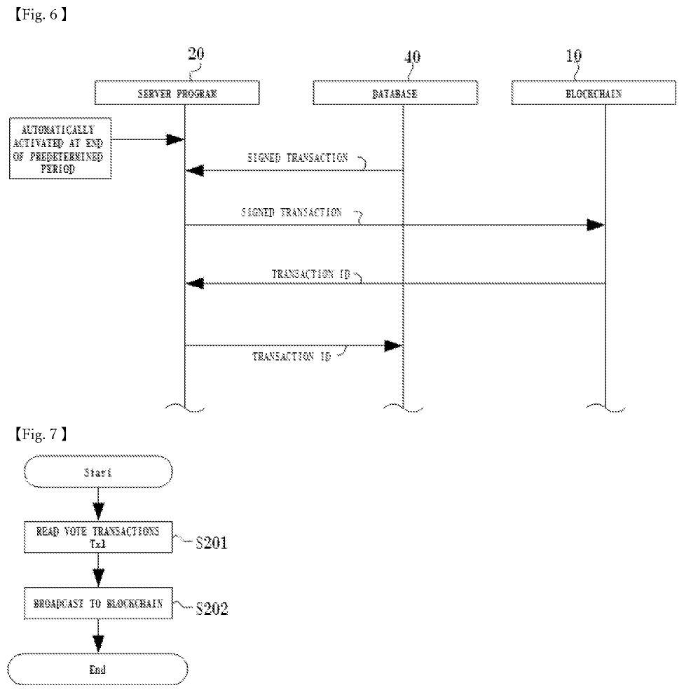

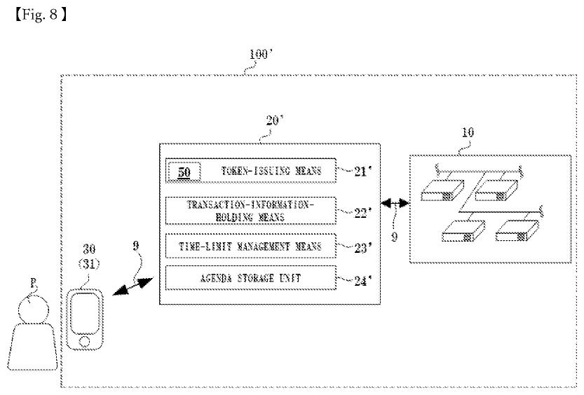

As illustrated in FIG. 5, the voting tokens 50 are signed by using the private key 34 that corresponds to each voting account on the voting application 31 and a vote transaction Tx1 is created (step S106).

The vote transaction Tx1 is a transaction for a transfer from the voting account to the vote-receiving accounts Qy and Qn set in advance for each of the agenda items Q1 to Q5 in the agenda storage unit 24 of the server 20, and the vote transaction Tx1 is temporarily held to thereby complete provisional voting (step S107).

In the present invention, in response to, for example, a choice of Yes being made about the agenda item Q1 by a transfer of the voting token 50, one voting token 50 for the agenda item Q1 is “cast” by the user P to the vote-receiving account Qy. Similarly, in response to a choice of Yes being made about the agenda item Q2, one voting token 50 for the agenda item Q2 is “cast” by the user P to the vote-receiving account Qy. Note that the vote-receiving accounts Qy and Qn may be common accounts regardless of the agenda items, and an agenda item to which a vote is cast may be distinguished by changing the type of the voting token 50, or the vote-receiving accounts Qy and Qn may be provided for each of the agenda items separately.

The voting tokens 50 as described above are associated with the shareholder information of the user P and issued to the voting account in the voting application 31, and therefore, duplication is difficult and the number of voting tokens 50 is determined on the basis of the number of agenda items and the number of voting rights.

With the above-described configuration, the number of voting tokens 50 corresponding to each agenda item and owned by each of the vote-receiving accounts Qy and Qn is counted to thereby allow checking of the number of votes cast by the users P.

At this time point, the transfer of the voting tokens 50 to the vote-receiving accounts is not broadcast to the blockchain 10, and therefore, the vote transaction Tx1 for a transfer from the voting account of the user P to each of the vote-receiving accounts Qy and Qn in the agenda storage unit 24 remains present, and the vote transaction Tx1 is in a provisional voting state in which, for example, erasure or correction is allowed.

The transaction-information-holding means 22 temporarily saves the vote transaction Tx1 (step S108).

The vote transaction Tx1 saved in the transaction-information-holding means 22 is in the provisional voting state in which, for example, erasure or correction is allowed as described above.

The voting application 31 determines whether a new voting instruction is given by the user P (step S109).

When the user P who wants to recast their votes performs re-voting in step S107, the voting application 31 overwrites the vote transaction Tx1.

Specifically, the transaction-information-holding means 22 saves the vote transaction Tx1 signed by using the same voting account, that is, the same private key 34, so as to be overwritten with the latest votes.

On the other hand, when it is determined in step S109 that a new voting instruction is not given, the voting application 31 maintains a standby state until a predetermined time limit expires (step S110).

In the provisional voting state in which the user P finishes voting in step S106 to S108 and a predetermined period does not yet end, the server 20 can check the signed vote transaction Tx1 saved in the transaction-information-holding means 22 against the number of shares of the user P to thereby display vote results in the provisional voting state.

Therefore, the voting application 31 may be configured to be capable of displaying the results of counting the voting tokens 50 in the provisional voting state.

Operations of the voting application 31, the server 20, and the blockchain 10 when the predetermined time limit expires after voting using the voting application 31 has been performed will be described.

The time-limit management means 23 reads the vote transactions Tx1 remain saved in the transaction-information-holding means 22 at the time point when a predetermined period, such as a voting day, ends (step S201), and transmits the vote transactions Tx1 that have been signed to the blockchain 10 (step S202).

In response to the vote transactions Tx1 being written to the blockchain 10, the vote transactions Tx1 are certified.

Therefore, the time-limit management means 23 functions as “a recording means for recording pieces of transaction information Tx recorded in the transaction-information-holding means 22 on the blockchain 10 at the end of the predetermined period”.

Note that the time-limit management means 23 may be a means, such as a crawler bot, for broadcasting the vote transactions Tx1 saved in the transaction-information-holding means 22 each time a predetermined period determined in advance ends, instead of the means for recording pieces of transaction information Tx on the blockchain 10 at the end of a predetermined voting day.

The timing when pieces of transaction information Tx are broadcast may be a timing specified during design or may be a timing specified as desired by the operator of the server 20.

The voting application 31 may be configured so as to be capable of displaying not only the result of counting for the vote transaction Tx1 in the provisional voting state but also the certified vote results on the basis of the vote transactions Tx1 recorded on the blockchain 10 after the end of the predetermined period determined by the time-limit management means 23. In this case, the mobile terminal 30 and the server 20 have a function of a vote result display means for displaying the vote results.

Reading the vote results from the blockchain 10 makes the displayed vote results more accurate than in a case of simply displaying the vote results on the basis of the number of temporarily saved voting tokens 50.

The above-described configuration contributes to improvement in transparency and reliability of the vote results.

When the number of voting tokens 50 owned by each of the vote-receiving accounts Qy (Q1y, Q2y, Q3y, Q4y, and Q5y) and the vote-receiving accounts Qn (Q1n, Q2n, Q3n, Q4n, and Q5n) in the agenda storage unit 24 are counted, the vote results can also be displayed.

According to this embodiment, the voting system 100 is a voting system using a distributed ledger for voting by transferring a voting token from a voting account to a vote-receiving account over a network, the voting system 100 including: the token-issuing means 21 for issuing the voting token 50 to the voting account generated by the account generation means 32; the transaction-information-holding means 22 for holding during a predetermined period, the transaction information Tx for transferring the voting token 50 from the voting account to the vote-receiving account; and the time-limit management means 23 for recording the transaction information Tx recorded in the transaction-information-holding means 22 on the blockchain 10 at the end of the predetermined period.

With the above-described configuration, re-voting is allowed “during the predetermined period”, that is, before the voting day, in which the vote transaction Tx1 remains saved in the transaction-information-holding means 22, and the vote transaction Tx1 is broadcast to the blockchain 10 when the “predetermined period” ends and the vote results are certified.

According to this embodiment, in the voting system 100, the vote transaction Tx1 held in the transaction-information-holding means 22 is held so as to be allowed to be overwritten during the predetermined period.

With the above-described configuration, re-voting is allowed “during the predetermined period”, that is, before the voting day, in which the vote transaction Tx1 remains saved in the transaction-information-holding means 22.

According to this embodiment, the voting system 100 includes the shareholder information providing means 41, in which the token-issuing means 21 determines the number of voting tokens 50 to be issued, on the basis of shareholder information of the user P obtained by the shareholder information providing means 41.

With the above-described configuration, the voting tokens 50 are associated with the shareholder information of the user P and issued to the voting account in the voting application 31, which makes duplication difficult, and the number of voting tokens 50 is determined on the basis of the number of agenda items and the number of voting rights, which can allow checking of the numbers of votes from users by counting the number of voting tokens 50 owned by each of the vote-receiving accounts Qy and Qn.

According to this embodiment, the vote transaction Tx1 is signed by using each private key 34 that is the voting account and held in the transaction-information-holding means 22.

With the above-described configuration, re-voting is allowed “during the predetermined period”, that is, before the voting day, in which the vote transaction Tx1 remains saved in the transaction-information-holding means 22.

The program used in the voting system 100 according to this embodiment is a voting program using the blockchain 10 for casting a vote to the vote-receiving accounts Qy and Qn over the network 9.

The voting system 100 according to this embodiment includes: a generation step S101 of generating a voting account for casting a vote; a token issuing step S105 of issuing the voting token 50 to the voting account; a temporary storage step S108 of temporarily storing the vote transaction Tx1 for the voting token 50 signed by using the voting account; and a recording step S202 of broadcasting the vote transaction Tx1 and recording the vote transaction Tx1 on the blockchain 10 at the end of a predetermined period.

With the above-described configuration, the voting system 100 allows re-voting during the period and makes tampering difficult after certification of votes.

When voting is performed by using the voting system 100, only a block that is signed by using the private key 34 is visible to the blockchain 10 in a distinguishable state.

The private key 34 is a voting account generated in response to the user P first logging in to the voting application 31, and the combination of the user P and the private key 34 is unknown to the blockchain 10. When the private key 34 is used in, for example, a usual election in which each voter is given one vote or is used in a survey, the user P is kept anonymous as described above.

However, regarding a shareholder vote that is a specific vote form, shareholder information including the number of shares may be made public in a case of, for example, a listed company.

If votes cast by using a specific private key 34 and recorded on the blockchain 10 can be counted, the user P may be identified.

Therefore, in a second embodiment of the present invention, the account generation means 32 in the voting system 100 may generate a plurality of voting accounts for a user P on the basis of shareholder information obtained by the shareholder information providing means 41.

Specifically, in step S101 in the first embodiment, the voting application 31 may create a plurality of pairs of private keys 34, which are voting accounts, and public keys for a single user P.

With the above-described configuration, regardless of shareholder information of the user P, one voting token 50 of one type is distributed to each voting account (private key 34).

Therefore, the voting tokens 50 need not be signed by using the same private key 34, which makes identification of the user P based on only information made public to the blockchain 10 difficult.

According to the second embodiment, the private keys 34 are also managed only on the voting application 31, which allows the user P to perform voting without specifically paying attention to the appropriate use of voting rights.

In voting by using a plurality of voting accounts as described above, votes are generally signed by different private keys 34 respectively, which imposes a risk that time taken to perform calculation processing by the voting application 31 increases; however, in the second embodiment, in actuality, the vote transaction Tx1 is not immediately recorded on the blockchain 10 but is only temporarily saved in the transaction-information-holding means 22. Therefore, in this embodiment, the voting application 31 may be configured to first provide a notification of voting completion on the display to the user P, and perform signing using a plurality of accounts in background processing. Using such a processing method contributes to improvement in the anonymity of the user P without compromising usability.

In a third embodiment of the present invention, the shareholder information providing means 41 and the database 40 may be omitted.

The shareholder information providing means 41 may be omitted in a case of a voting system 100′ that is used in, for example, a survey or a ballot for, for example, an election.

Specifically, in a case of an election, a notification distributed to each eligible voter from the local government as a polling station pass needs to include the way of obtaining the voting application 31 using the mobile terminal 30 and login information including an ID and a password for the user P.

FIG. 8 illustrates an example overall configuration of the voting system 100′ for voting over the network 9.

In this embodiment, a description is given under the assumption that the voting system 100′ is a voting system for the users P, who are eligible voters or answerers to a survey, to reply to each of the plurality of agenda items with Yes or No.

The voting system 100 includes the mobile terminal 30 on which the voting application 31 is installed, a server 20′, and the blockchain 10 that is a distributed ledger and on which vote results are recorded.

The mobile terminal 30 is a mobile terminal that is owned by the user P and on which the voting application 31 is installed, and has a communication function of allowing the mobile terminal 30 to be individually connected to the server 20 over the network 9.

Regarding the functional configuration, a description of a part configured as in the first embodiment will be omitted as appropriate.

As illustrated in FIG. 8, the server 20′ includes a token-issuing means 21′ for issuing the voting tokens 50 and a transaction-information-holding means 22′ for temporarily saving the transaction information Tx that has been signed and transmitted from the voting application 31.

The server 20′ further includes a time-limit management means 23′ for broadcasting together pieces of signed transaction information Tx that remain held by the transaction-information-holding means 22 at the end of a predetermined period, to the blockchain 10.

In this embodiment, the server 20′ includes an agenda storage unit 24′ that functions as vote-receiving accounts and is used to store the plurality of agenda items Q1 to Q5.

In the agenda storage unit 24′, for the agenda items Q1 to Q5 that are, for example, agenda items for a shareholder vote, the vote-receiving accounts Q1y, Q2y, Q3y, Q4y, and Q5y to which the voting tokens 50 are cast for a vote in favor and the vote-receiving accounts Q1n, Q2n, Q3n, Q4n, and Q5n to which the voting tokens 50 are cast for a vote in against are respectively saved as addresses.

In the third embodiment, the token-issuing means 21′ issues one voting token 50 of one type to each user P in accordance with the number of the agenda items Q1 to Q5.

That is, in a case of five agenda items, one of each of the five types of voting tokens 50 is distributed to a voting account created in the voting application 31.

With the above-described configuration, each user P can cast one vote for each of the agenda items Q1 to Q5.

As described above, each user can cast one vote, the vote can be easily changed until the time limit expires, and the vote is not allowed to be changed after the time limit, which provides an effect of, for example, facilitating early voting for a national election.

In a case of an election, instead of, for example, the vote-receiving accounts Q1y, Q1n, . . . corresponding to Yes/No of the agenda items Q1 to Q5, for each of the plurality of candidates in an election district, a vote-receiving account for each of the candidates may be generated. In this case, the agenda storage unit 24′ generates a plurality of vote-receiving accounts corresponding to the respective candidates.

Descriptions of the operations and configuration of the voting system 100 overlap those given in the first and second embodiments, and therefore, will be omitted here.

Although preferred embodiments of the present invention have been described above, the present invention is not limited to such specific embodiments, and various modifications and changes can be made without departing from the scope of gist of the present invention as set forth in the claims, unless otherwise specifically limited in the descriptions given above.

For example, in terms of the time limit of voting, the time-limit management means 23 may be a means, such as a crawler bot, for broadcasting the vote transactions Tx1 saved in the transaction-information-holding means 22 each time a predetermined period determined in advance ends.

The timing when pieces of transaction information Tx are broadcast may be a timing specified during design or may be a timing specified as desired by the operator of the server 20.

The blockchain 10 may be a private chain or a public chain.

Using a public chain as the blockchain 10 further improves protection against tampering and ensures transparency and reliability of the vote results.

The effects described in the embodiments of the present invention are merely effects listed as the most preferred effects provided by the present invention, and the effects provided by the present invention are not limited to those described in the embodiments of the present invention.

### REFERENCE SIGNS LIST

10 blockchain (distributed ledger)
20 server
21 token-issuing means
22 transaction-information-holding means
23 time-limit management means (recording means)
24 agenda storage unit
30 mobile terminal
31 voting application
32 account generation means
33 signing means
34 private key (voting account)
40 database
41 shareholder information providing means
50 voting token
100 voting system
Qy (Q1y, Q2y, Q3y, Q4y, Q5y) vote-receiving account
Qn (Q1n, Q2n, Q3n, Q4n, Q5n) vote-receiving account
Tx, Tx1 transaction information, vote transaction

1. A voting system using a distributed ledger for voting by transferring a voting token from a voting account to a vote-receiving account over a network, the voting system comprising:
token-issuing means for issuing a voting token to the voting account generated by account generation means;
transaction-information-holding means for holding during a predetermined period, transaction information for transferring the voting token from the voting account to the vote-receiving account; and
recording means for recording the transaction information recorded in the transaction-information-holding means on the distributed ledger at an end of the predetermined period.

2. The voting system according to claim 1, wherein
the transaction information held in the transaction-information-holding means is held so as to be allowed to be overwritten during the predetermined period.

3. The voting system according to claim 1, comprising:
shareholder information providing means for associating the voting account with shareholder information of an owner of the voting account, wherein
the token-issuing means determines the number of voting tokens to be issued, on the basis of the shareholder information obtained by the shareholder information providing means.

4. The voting system according to claim 1, wherein
the transaction information is signed by using each of the voting accounts and held in the transaction-information-holding means.

5. The voting system according to claim 1, comprising:
shareholder information providing means for associating the voting account with shareholder information of an owner of the voting account, wherein
the account generation means generates a plurality of voting accounts of the owner on the basis of the shareholder information obtained by the shareholder information providing means.

6. A voting program using a distributed ledger for casting a vote to a vote-receiving account over a network, the voting program comprising:
a generation step of generating a voting account for casting the vote;
a token issuing step of issuing a voting token to the voting account;
a temporary storage step of temporarily storing transaction information of the voting token signed by using the voting account; and
a recording step of broadcasting the transaction information and recording the transaction information on the distributed ledger at an end of a predetermined period.

7. The voting system according to claim 2, comprising:
shareholder information providing means for associating the voting account with shareholder information of an owner of the voting account, wherein
the token-issuing means determines the number of voting tokens to be issued, on the basis of the shareholder information obtained by the shareholder information providing means.

8. The voting system according to claim 2, wherein
the transaction information is signed by using each of the voting accounts and held in the transaction-information-holding means.

9. The voting system according to claim 3, wherein
the transaction information is signed by using each of the voting accounts and held in the transaction-information-holding means.

10. The voting system according to claim 2, comprising:
shareholder information providing means for associating the voting account with shareholder information of an owner of the voting account, wherein
the account generation means generates a plurality of voting accounts of the owner on the basis of the shareholder information obtained by the shareholder information providing means.

11. The voting system according to claim 3, comprising:
shareholder information providing means for associating the voting account with shareholder information of an owner of the voting account, wherein
the account generation means generates a plurality of voting accounts of the owner on the basis of the shareholder information obtained by the shareholder information providing means.

12. The voting system according to claim 4, comprising:
shareholder information providing means for associating the voting account with shareholder information of an owner of the voting account, wherein
the account generation means generates a plurality of voting accounts of the owner on the basis of the shareholder information obtained by the shareholder information providing means.
